(19) United States
(12) Patent Application Publication
(10) Pub. No.: US 2021/0251193 A1
(43) Pub. Date: Aug. 19, 2021

(54) The Catch Bag

(71) Applicant: Heather Ann Gregson, Medford, MA (US)

(72) Inventor: Heather Ann Gregson, Medford, MA (US)

(21) Appl. No.: 16/793,234

(22) Filed: Feb. 18, 2020

(51) Int. Cl. A01K 23/00; B65D 33/28

(52) U.S. Cl. CPC A01K 23/005; B65D 33/28

(57) ABSTRACT

The Catch Bag is an invention to address the process of animal feces collection and disposal. It is a flat sheet designed with draw strings that are used to cinch the sheet forming a bag to contain the fecal matter, thus eliminating direct or indirect contact with the waste, and thereby removing any need to handle the waste by glove or other commonly used barrier. The sheet is positioned to catch the excrement prior to the animal defecating. After which the cinch strings are pulled forming the bag around the waste. The bag is closed and can then be tied and easily disposed of.

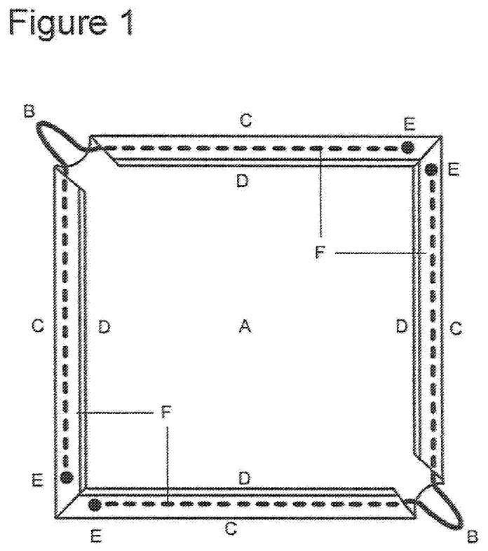

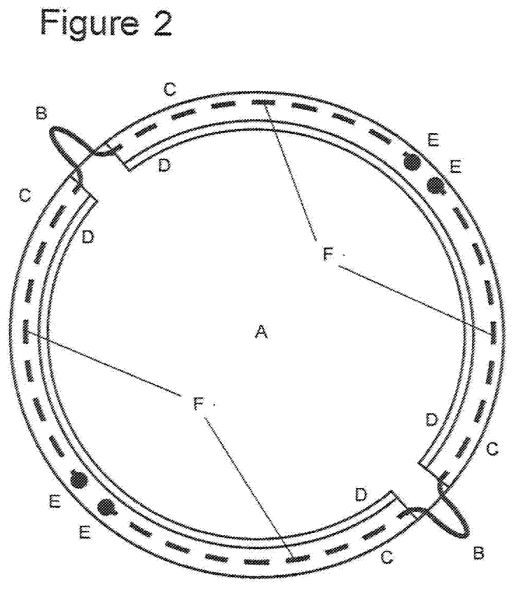

### FIGS. 1 and 2.

A. Impermeable sheet.

The base material for the invention is a sheet of impermeable material, similar to the average plastic grocery bag or trash bag, strong enough to contain the animal waste without being damaged. While impermeability is not imperative, and there are many materials capable of performing adequately, it is this inventors opinion that a leak proof barrier is preferable for containment and disposal with regard to toxicity.

B. Draw strings.

The draw strings are the primary element of the invention. When tugged against each other the sheet assumes the shape and function of a bag to contain the contents securely. How the strings are incorporated is less relevant than the result of enclosing the waste for proper disposal. While many manner of threading was explored, the end result is simply to close the package.

C. Folds to form string pockets.

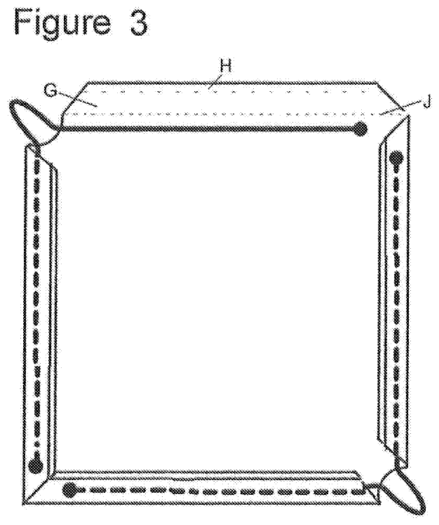

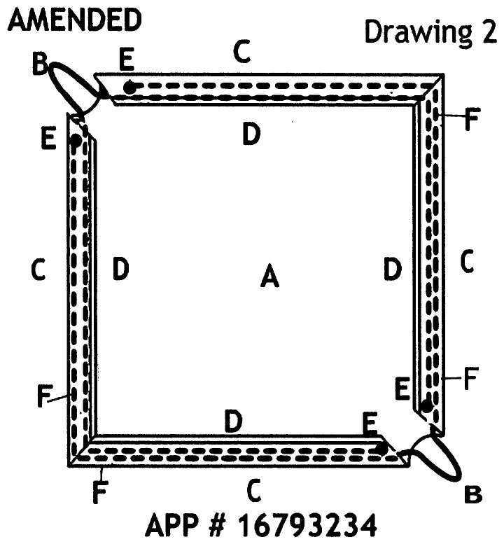

The initial material is cut in such a way as to allow flaps to be folded over the draw strings (FIG. 3) and sealed to itself forming pockets that provide guidance to direct the course of the strings. Bonding the folded material can be achieved by heat, chemicals or adhesive. Another means would be threading the string though pilot holes somewhat like a shoe string. The shape (FIGS. 1 and 2) or how the string is secured is less relevant than its function of closing the package.

D. Sealed pocket folds.

The seals to form the pockets are achievable in a number of ways. There are glues and processes a plenty to stick materials to materials. What manner used to constrain the material is less relevant than the function that the guide performs.

E. Draw string anchor points.

This inventor experimented with many ways to insert the draw strings. There were loops and double loops, tied, glued, crossed, and woven. It was the decision of this inventor to use the manner presented in figure one, but how the string is incorporated into the design is less relevant than its function of closing the package.

### FIG. 3.

G. Flap.

H. Area of bond or seal.

J. Fold line.

Photo 1. Shows two phases of the forming of the bag, closing and closed.

1. The inventor of The Catch Bag claims the sole rights to any and all sheets, pads, planes, or bags of any kind that catch and cinch by string, line or cord and/or tie for the purpose of containment and/or disposal of animal excrement.
